(19) United States
(12) Patent Application Publication
(10) Pub. No.: US 2017/0337839 A1
(43) Pub. Date: Nov. 23, 2017

(54) Methods and Devices for Behavior Modification

(71) Applicants: Stuart Yudofsky, Houston, TX (US); Emily Yudofsky, Houston, TX (US)

(72) Inventors: Stuart Yudofsky, Houston, TX (US); Emily Yudofsky, Houston, TX (US)

(21) Appl. No.: 15/589,750

(22) Filed: May 8, 2017

Related U.S. Application Data
(60) Provisional application No. 62/338,672, filed on May 19, 2016.
(60) Provisional application No. 62/345,159, filed on Jun. 3, 2016.
(60) Provisional application No. 62/360,885, filed on Jul. 11, 2016.
(60) Provisional application No. 62/382,128, filed on Aug. 31, 2016.

(51) Int. Cl. G09B 9/00; G09B 5/00; G09B 19/00; G09B 5/02; G06F 3/01

(52) U.S. Cl. CPC G09B 9/00; G09B 19/0092; G09B 19/00; G09B 5/02; G09B 5/00; G06F 3/013; G06F 3/012

(57) ABSTRACT

The invention provides systems and methods for behavior modification in a subject using a virtual reality or augmented reality system. The invention may be used to acutely modify behaviors or cravings or may be used to induce classic aversive conditioning. The modified behaviors may include, for example, to prevent, mitigate or eliminate unhealthy, undesired, socially unacceptable, or dysfunctional behaviors.

### CROSS-REFERENCE TO RELATED APPLICATIONS

This application claims priority to each of the following United States provisional patent applications: Ser. No. 62/338,672, filed May 19, 2016; Ser. No. 62/345,159, filed Jun. 3, 2016; Ser. No. 62/360,885, filed Jul. 11, 2016; and Ser. No. 62/382,128, filed Aug. 31, 2016. Priority to the provisional patent applications is expressly claimed, and the disclosure of the provisional applications is hereby incorporated herein by reference in their entireties and for all purposes.

### FIELD

The subject matter of the present application relates generally to methods and devices for delivering aversive stimuli to mitigate addictive and other undesirable, unhealthful, and/or unwanted behaviors.

### BACKGROUND OF THE INVENTION

Behavior reinforcement is a process that uses positive reinforcement (reward) to increase the frequency of a desired behavior and/or aversive conditioning (penalty) to reduce the frequency of an undesired behavior. Aversive conditioning of various types is known to be useful for reducing the frequency of unhealthful behaviors if the aversive stimulus can be successfully paired with the behavior. Important parameters in behavior reinforcement are type, the schedule and immediacy of reinforcement, the nature of the aversive stimulus, and the severity of that stimulus.

Aversive stimuli may be administered on a continuous schedule, whereby every instance of a behavior is reinforced, or on an intermittent reinforcement schedule, whereby reinforcement occurs only with some instances of a particular behavior. Variable-ratio schedules tend to motivate people more and result in longer-lasting positive behaviors than if the same amount of reinforcement were distributed on a continuous schedule. This is partly because variable-ratio intermittent reinforcement leads to emotions of anticipation, suspense, and uncertainty. It appears to involve key emotional, cognitive, and memory centers and circuits in the brain. The immediacy of the reinforcement, i.e., the delay between the behavior and the reinforcement, is ideal if kept to a minimum. For example, the burning sensation associated with the touching a red-hot coal is a highly-effective aversive stimulus that is delivered immediately upon, and results directly from the deleterious behavior of direct contact with the hot coal. Similarly, aversive conditioning may be used to modify and/or eliminate a variety of unhealthful and/or undesired behaviors that affect health and wellness. Aversive conditioning is improved when it is accompanied by an immediate positive reinforcement or reward including, for example, an immediate cessation of the aversive stimulus when the undesired behavior ceases.

Smoking is a prototypical addiction that has a high prevalence and deleterious health consequences for the smoker and those exposed to second-hand smoke. Cigarette smoking is the leading cause of preventable death in the United States and around the world. The CDC estimates that cigarette smoking increases the annual U.S. healthcare costs by about $400 billion. Many smokers would like to stop smoking but are unable to do so with the options that are readily available to them. The CDC estimates that >70% of smokers wish to stop smoking and >50% have attempted to stop within the last twelve months. However, despite the strong desire, only about 6% of smokers are able to abstain for more than six months. Accordingly, there is a need for behavior reinforcement and modification programs to address the cessation of smoking and other unhealthy and/or addictive behaviors within the population.

### BRIEF DESCRIPTION OF THE DRAWING

FIG. 1 is a block diagram of one embodiment of a virtual reality (VR) system 10 comprising a head-mounted display 20, one or more head motion tracking sensors 30, and a VR input interface 40.

### SUMMARY OF THE INVENTION

The present invention provides methods, devices, and systems for delivering an aversive stimulus to a subject in order to mitigate, reduce, or eliminate addictive and other undesirable, unhealthful, and/or unwanted behaviors. The methods, devices, and systems deliver an aversive stimulus to the subject for behavioral conditioning and/or deliver an aversive stimulus to mitigate, reduce, or eliminate the behavior without necessarily inducing classical conditioning or requiring the subject to engage in the unwanted behavior. Alternatively, the methods, devices, and systems may be used once or repeatedly to induce emesis (vomiting) in order to empty the stomach contents of a subject without the risks and adverse effects associated with chemical emetics.

In one aspect, the invention provides a method for aversively conditioning a behavior in a subject by: (i) performing a training session by (a) providing a virtual reality or augmented reality system and software for creating a virtual reality environment and/or virtually-augmented environment (i.e., virtual environment) that may be experienced (i.e., viewed) by the subject using the system (i.e., deliver an aversive stimulus to the subject), wherein the virtual environment is capable of inducing an adverse physiological effect when experienced by the subject; (b) having the subject experience the virtual environment while engaging in the behavior until the adverse physiological effect is effected; and (c) terminating the behavior and the virtual environment experience; (ii) providing an interval period, wherein the subject abstains from the behavior, and (iii) repeating the training session of step (i) one or more times, wherein the interval period of step (ii) is provided between each repetition.

In some embodiments, the invention further comprises a step of identifying a behavior for adverse conditioning in the subject before step (i). In some embodiments the behavior for adverse conditioning is identified by a doctor or the subject.

In some embodiments, step (ii) is repeated at least 2, 3, 4, 5, 6, 7, 8, 9, 10, 15, 20, 25, 30, or more times. In other embodiments, the interval period is about 2, 4, 6, 8, 10, or 12 hours, less than one day, or about 1, 2, 3, 4, 5, 6, 7, or more days.

Optionally, the magnitude of the aversive stimulus is varied (i.e., increased or decreased) in at least one repetition of step (ii) relative to an earlier repetition.

In another aspect, the invention provides a method for mitigating an unwanted behavior in a subject by: (i) identifying an unwanted behavior in a subject; (ii) identifying a time period during which the subject has a desire to engage in the behavior; (iii) inducing an adverse physiological effect in the subject by: (a) providing a virtual and/or augmented reality system and software for creating a virtual environment that may be experienced (i.e., viewed) by the subject using the virtual reality or augmented reality system (i.e., deliver an aversive stimulus to the subject), wherein the virtual environment is capable of inducing the adverse physiological effect when experienced by the subject; and (b) having the subject experience the virtual environment during the time period until the adverse physiological effect is effected; and (iii) terminating the virtual environment experience when the subject no longer has a desire to engage in the behavior.

In some embodiments, step (iii) is repeated at least 2, 3, 4, 5, 6, 7, 8, 9, 10, 15, 20, 25, 30, or more times. In other embodiments, the interval period is about 2, 4, 6, 8, 10, or 12 hours, less than one day, or about 1, 2, 3, 4, 5, 6, 7, or more days.

Optionally, the magnitude of the aversive stimulus is varied (i.e., increased or decreased) in at least one repetition of step (iii) relative to an earlier repetition.

In some embodiments, the dysfunctional behavior involves the self-administration (e.g., by ingestion, injection, or inhalation) of an exogenous substance including, for example, prescription or non-prescription pharmaceuticals (e.g., opioids, stimulants) or illegal substances of abuse (e.g., heroin, cocaine, marijuana—in most jurisdictions, etc.). Other common examples include smoking of tobacco, tobacco chewing, nicotine inhalants, drinking alcohol excessively, or ingestion of excess dietary sugars and/or carbohydrates. Other examples may involve lifestyle choices or behaviors such as unsafe illegal or unsavory sexual practices, compulsive gambling, and video game addiction.

In some embodiments, the adverse physiological effect is motion sickness, dizziness nausea, vomiting, and/or disgust or revulsion.

In another aspect, the invention provides a method for inducing emesis (vomiting) in a subject by (i) providing a virtual and/or augmented reality system and software for creating a virtual environment that may be experienced (i.e., viewed) by the subject using the virtual reality or augmented reality system, wherein the virtual environment is capable of inducing vomiting when experienced by the subject; (ii) having the subject experience the virtual environment during the time period until vomiting is effected; and (iii) terminating the virtual environment experience after the subject has vomited.

In some embodiments, vomiting is induced without prior or simultaneous administration of an emetic (e.g., Ipecac). In other embodiments, the subject is identified as having ingested (i.e., orally administered) a toxic substance or an excessive dose (e.g., an overdose) of a prescription or illicit pharmaceutical or pharmacoactive substance (e.g., prescription pharmaceuticals including analgesics).

In some embodiments, step (ii) is repeated at least 2, 3, 4, 5, or more times. In other embodiments, the interval period is about 2, 4, 6, 8, 10, 12, 15 minutes, or more. In other embodiments, step (ii) is performed less than 0.5, 1, 2, 3, 4, or hours after the subject has ingested the toxic substance. Optionally, the magnitude of the aversive stimulus is varied (i.e., increased or decreased) in at least one repetition of step (iii) relative to an earlier repetition.

In some embodiments of any of the foregoing aspects, the virtual environment is a motion simulator such as a flight simulator, a driving simulator, or a simulator that displays images simulating the motion associated with being on a rocking boat, spinning carnival rides (e.g. Tilt-A-Whirl; Mad Hatter's Tea Party, etc.), roller coaster, or other moving vehicle. For embodiments in which disgust or revulsion is the aversive stimulus, the visual and/or olfactory representations may include, for example, feces, urine, pus, or vomit; spoiled or spoiling edible substances like rotting meats or spoiled milk products; animal infestations such as rats, ticks, cockroaches, lice; diseased body parts such as cutaneous and subcutaneous infections, or cancer-riven lungs or genitalia; injured organs such as a pierced eyeball; or decomposing or decaying human or animal bodies. In other embodiments, the virtual environment is an augmented reality environment in which computer-generated images are superimposed within the subject's field of view of an actual/real environment. In some embodiments, the virtual environment comprises an icon or avatar representing the subject wherein the icon or avatar is placed in an unpleasant environment subjected to unpleasant procedures. In some embodiments, the unpleasant environment is a cancer hospital. In some embodiments, the subject is subjected to chemotherapy, radiotherapy or surgical procedures associated with cancer, e.g. lung cancer. In some embodiments, the unpleasant procedure further comprises graphic representations of the disfiguring and deteriorating corporal changes of the subject's avatar that are commonly associated with advanced lung cancer and its treatments. In some embodiments, the period for adverse physiological effect to be effected is reduced.

In other embodiments of any of the foregoing aspects, the virtual environment involves administering an aversive stimulus using a second or additional sensory modalities, other than vision including, for example gustatory, olfactory, auditory, and/or tactile stimuli.

In some embodiments of any of the foregoing aspects, the aversive stimulus is administered for at least 1, 2, 3, 4, 5, 10, 15, 20 minutes or more. Optionally, the magnitude of the aversive stimulus is increased, continuously or incrementally, over the duration of administration and/or among successive virtual environment viewing sessions. In some embodiments, the magnitude of the aversive stimulus in increased by introducing and/or increasing the delay of latency.

In another aspect, the invention provides a virtual reality or augmented reality system having (i) a plurality of display devices configured to be viewed by a subject; (ii) a software program capable of displaying a first image on the display devices in response to a subject's first point of view and a second image on the display devices in response to a subject's second point of view, wherein the second image is related to the first image by the difference between the second point of view and the first point of view; (iii) a sensor capable of detecting a subject's first point of view at a first time and a subject's second point of view at a second time; wherein the software program is configured to provide a latency of 50 milliseconds (ms) or more (e.g., 60, 75, 100, 125, 150, or 200 ms) between a detection in the second point of view by the sensor and the display of the second image; or a device and software capable of superimposing sensory stimuli onto the “real” environment or altering the real environment to induce nausea and/or motion sickness.

The sensor may be adapted to detect a change in the position a head, an eye, or both eyes of the subject.

By “avatar” is meant to be a graphical representation of the subject or the subject's alter ego or character.

By “aversive stimulus” is meant the stimulus delivered to a subject that is intended to induce an aversive condition. An aversive stimulus may be delivered by any sensory modality (e.g., visual, olfactory, gustatory, auditory, and tactile) or combination of modalities simultaneously or in series. For example, an aversive stimulus may be a visual stimulus such as a motion simulator that, optionally, may be paired with a noxious smell and/or a disgusting sound. Although aversive stimuli may be administered by any of these modalities using any appropriate means, the present application focuses on the delivery of aversive stimuli using VR/AR systems that create a virtual environment (VE) experienced by the subject.

By “aversive condition” or “adverse physiological effect” is meant the unpleasant (i.e., aversive) physiological condition induced in a subject exposed to an aversive stimulus. For example, aversive conditions include a feeling of pain, nausea, or dizziness, disgust or revulsion, and/or physical manifestations of nausea such as vomiting.

### DETAILED DESCRIPTION

The present invention provides methods and devices for delivering averse stimuli using virtual reality (VR) and/or augmented reality (AR) devices in order to prevent or mitigate existing addictive and other undesirable, unhealthy, and/or unwanted behaviors. In some embodiments, the unwanted behavior is modified through the process of aversive conditioning. In other embodiments, the unwanted behavior is acutely modified or extinguished by the temporaneous or contemporaneous administration of the aversive stimulus, sufficient to induce the aversive condition, during the craving or desire phase of the behavior but without the subject actually engaging in the unwanted behavior. These latter embodiments do not necessarily involve classic conditioning.

Nausea and Disgust as Aversive Conditions

Aversive learning/conditioning has evolved as mechanism to protect the organism against environmental dangers. Aversive conditioning occurs naturally when a subject is exposed to biologically harmful events or damaging substances that cause the subject pain or discomfort. The learning process occurs when the subject learns to associate the source of the stimulus with the painful or unpleasant sensation resulting in the subject learning to avoid that source. Aversive learning is primarily a survival function to condition the animal (e.g., a human) to avoid harmful products and situations. Thus, it is possible to modify the behavior of a subject by pairing an unwanted behavior or situation with an externally-delivered aversive stimulus that is normally unrelated to that behavior/situation, in order to affect a behavior modification resulting in avoidance.

Nausea, including involuntary vomiting, is one particular aversive condition that has evolved in most animal species as a survival function against vegetative poisonous substances such as those found in many species of plants and other substances that are deleterious to the organism. Nausea, therefore, causes the animal to limit or avoid ingestion of the poisonous substance and its source. Nausea also may be dose-related in order to prevent ingestion of too much of a substance that may be safe in small amounts but deleterious in larger quantities. A common example of dose-related nausea involves the intake of alcohol. Aversive conditioning and/or behavioral modification occurs when the aversive condition (e.g., nausea) is paired with the unhealthful behavior (e.g., ingestion of a toxic substance). After experiencing the aversive condition in response to the stimulus, the aversive condition then may become a conditioned response to a sensory stimulus in order cause the organism to avoid the unhealthful behavior. For example, a conditioned individual may become nauseated upon merely tasting the noxious substance based on its previous experience even though merely tasting the substance would not induce nausea in an unconditioned individual.

Nausea and/or vomiting also may be induced by sensory stimuli other than taste and smell including, for example, in response to visual or proprioceptive stimuli. Nausea and/or vomiting can be induced by “illusory experiences” that are primarily or solely visual (e.g., by watching another person vomit). Motion-induced nausea may be induced a sensory conflict between a subject's body position (proprioception) and its visual and other perceptions of the external space. Proprioceptive nausea may be induced by watching a motion videos (e.g., first-person or point-of-view videos of a rocking boat or being on a spinning vehicle) that occupy most or all of the subject's visual field. Nausea may also be induced by altering the subject's perception “real” environment (augmented reality) such as having it appear to spin around the stationary subject.

Revulsion or disgust is another aversive condition that may be induced by sensory stimuli using the methods and systems disclosed herein. Revulsion or disgust is a primary emotional protective response of animals to substances (e.g., poisonous or biologically-contaminated foods) or activities that endanger the survival of the individual. In addition to visual stimuli, olfactory stimuli are particularly useful for inducing revulsion or disgust.

As with many other biologically/psychologically based symptoms such as headache (the most common medical symptom) and even nausea, the manifestations of disgust/revulsion are primarily subjective. Nonetheless, tests exist that reliably quantify this phenomenon. In one test, for example, eight isolated and codable domains were identified that can elicit disgust. (Haidt, J., McCauley, Rozin, P. Individual differences in sensitivity to disgust: A scale sampling seven domains of disgust elicitors. Personality and Individual Differences, 16, 701-713, 1994.) These domains include (i) food that is spoiled or culturally unacceptable; (ii) sexual practices that are deviant or culturally unacceptable; (iii) body products that include feces, mucus, infections, and odors; (iv) animals that are slimy or live in dirty environments; (v) bodily injuries that include amputations, mutilations, disfigurements; (vi) elements involving death and dead bodies; (vii) human or animal hygiene that is deviant or culturally unacceptable; (viii) infections and contaminations. Identification of these domains led to the development of The Disgust Scale, which is a 32-item self-report scale to help identify individual differences in sensitivity to disgust. The Disgust Scale remains the most commonly—utilized measure. Examples of items to be rated by a subject include: “You see a man with his intestines exposed after an accident;” “You see a bowel movement left unflushed in a public bathroom;” “You see a rat run across your path in a park;” “You see maggots on a piece of meat in an outdoor garbage pail.” A three point scale of “not disgusting at all”, “slightly disgusting” or “very disgusting” were the rating points in the scale.

The AR/VR system described herein may be individually tailored to elicit disgust or revulsion as an aversive condition. For example, the subject may be administered a questionnaire prior to beginning AR/VR therapy or treatment to determine their general sensitivity to disgust (e.g., total score) and to identify domains to which they are more or less sensitive. When repeated AR/VR sessions are anticipated, the earlier sessions may present disgusting stimuli that are less intense and/or selected form domains to which the subject is relatively resistant. The intensity of the disgusting stimuli within a domain may be increased and/or disgusting stimuli from subjectively more sensitive domains may be used in subsequent AR/VR sessions, as desired to increase the intensity of the aversive stimuli and/or resulting aversive condition.

Virtual/Augmented Reality Systems and Virtual Environments

As used herein, a “virtual environment” (VE) generally refers to a virtual reality environment (VRE) and/or an augmented reality environment (ARE) which are simulated or augmented/enhanced (e.g., computer-generated) three-dimensional visual worlds viewed by a user. The VE optionally may be further enhanced using other non-visual stimuli as described herein. In some embodiments, the user may interact with the VE such that the computer-generated images appear to be reactive to various user inputs such as user motions, movements, and/or changes in the point of view. In other embodiments, the VE is not interactive such that the user has no apparent control over the VE while viewing the VE.

Virtual reality environment (VRE) is an artificial/“virtual” environment (VE) or simulated three-dimensional world that is created with software and presented to the user in such a way that the user may suspend belief and accept it as a real environment. The VRE occupies the user's entire field of vision such that all images viewed by the user within the VRE are computer-generated. Stated in another way, a virtual reality system is a software-based technology that replicates an environment, real or imagined, and simulates a user's physical presence and environment to allow for user interaction. The core of the VR system is the visual display on which the user views, and optionally interacts with, the VRE. However, VREs can artificially create any sensory experience, which can include sight, touch, hearing, and smell.

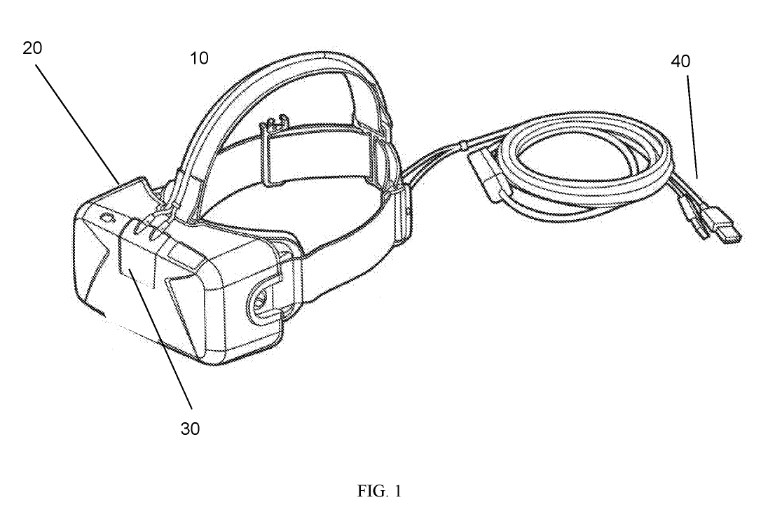

Many VR systems use head-mounted displays (HMD), which are headsets that contain two monitors, one for each eye, or utilize one display (such as a phone screen) with two separate side-by-side images (one for each eye). FIG. 1 is a block diagram of one embodiment of a VR system 10 comprising a head-mounted display 20, one or more head motion tracking sensors 30, and a VR input interface 40, which is a device that allows communication with a VR console or computer. However, computer screens or other displays also can be used to display the VR images. In some embodiments, the HIVID can further include one or more head motion tracking sensors such as, for example, gyroscopes, accelerometers, magnetometers, proximity sensors, a compass, structured light systems, and so on. The HIVID also may include headphones, eye tracking sensors, and gaming controllers.

The VR systems create the VE using software-based libraries. For example, object-oriented libraries may be used to build real-time three dimensional simulations and virtual world applications that run on the HIVID system and/or desktop computers. The libraries can define a simulation manager, a real-time rendering pipeline, an object manager, texturing functions, animation sequences, input sensors, lights and graphics display devices in a flexible object-oriented library. Video-realistic textures can be applied to object surfaces in any orientation and scale, enabling the creation of compelling and lifelike virtual reality worlds. Furthermore, the software can include drivers for many popular control devices and output devices so that the user can configure input and output. Head-tracking, gesture tracking, and object manipulation are accomplished by coupling sensors to graphical objects (or metaphors) and viewpoints.

The VR images create a stereoscopic effect, giving the illusion of depth. The immersive visual experience can, in some circumstances, be enhanced by pairing the visual VE with sound. More modern VR devices create VEs that may incorporate additional senses and stimuli including olfaction and may provide haptic feedback.

The use of passive haptics can enhance the user's interactivity and immersion with the VE. Passive haptics are real objects in a physical space that are mapped to virtual objects in a virtual space. Users wear an HIVID or similar portable display while in the physical space. A camera may be incorporated into the HIVID for gathering live visual information from the physical environment that may be digitized and/or digitally altered for projection and incorporation into the VE. When the user looks toward the physical object in the real environment, a virtual representation of it in the display in the VE. When the user approaches the object and tries to touch it, the user encounters the real object in the physical space. Anything the user does with that object in real space appears as a reflected action upon the virtual object in virtual space. The user's movements may be detected and tracked by the camera incorporated into the HMD for projection into the VE. Alternatively, or in addition to camera-based tracking, the user may have sensors attached to certain appendages (e.g., fingers, hands, and/or arms) that detect motion and positioning of that appendage. (See, for example, U.S. Pat. Nos. 6,515,669 and 8,868,373, and U.S. Patent Application Pub. No. 2008/0136775, hereby incorporated by reference.) The sensor data is processes and projected into the VE to correspond to the user's actual movements. Thus, passive haptics is a mechanism to bridge the physical and virtual environments simultaneously experienced by the user.

Users of VR, under certain circumstances, may experience adverse effects including motion sickness (sometimes referred to as cybersickness) while interacting with a VE. Motion sickness may manifest as a feeling of uneasiness, sweating, dizziness, headache, nausea, and/or vomiting. Motion sickness commonly occurs when a user's visual inputs regarding motion (e.g., as viewed on a screen) do not match the sensory inputs received from the vestibular system (e.g., no sensation of movement).

Motion sickness also may be caused by latency in the VR system. Latency is the lag time between when a user acts and when the VE reflects that action. Most commonly, latency occurs as the time delay between when a user turns her head or moves her eyes and the change in the point of view (POV) within the VE. Often the latency arises because of the delay in processing the input device signals detecting the user's movement and the time taken for the computer to render the graphics reflecting that change in POV associated with that movement. For example, the VR system can be provided with a refresh rate of the display that is less than 90 Hz, thereby introducing a latency of greater than fifteen milliseconds. “Swimming” is a term that describes the effect of latency within a VE, and latency alone is sufficient to cause motion sickness in some users. Studies with flight simulators show that humans can detect a latency of more than 50 milliseconds (ms).

Augmented reality (AR) systems, like VR systems, create an artificial environment (i.e., an ARE) through the use of computer-generated images displayed within the user's field of view. Unlike VR systems in which the user views only computer-generated images, an AR system allows the user to view and experience some or all of the real environment in which the user resides but enhances or augments that real environment by projecting computer-generated images into the field of view. Most commonly, AR systems involve the use of eyewear or goggles, or the like through which the user can view the real environment and which are also capable of projecting images onto a viewing screen such that the images are simultaneously viewed by the user. Preferably, the user perceives the computer-generated images as part of the real environment and does not consciously distinguish between real and virtual objects and visual experiences. AR systems also can be used to alter the real environment in such ways that will induce motion sickness, nausea, and/or disgust.

The present invention uses the adverse effects of VR and AR, including nausea involuntary vomiting, and/or disgust, as aversive stimuli to promote behavior modification to aid in the reduction or cessation of unwanted behaviors including, for example, unhealthy behaviors such as smoking.

Delivering Aversive Stimuli Using Virtual and Augmented Reality

Uncomfortable feelings, including motion sickness, dizziness, nausea, and/or disgust, can be induced when VR and/or AR are used as an aversive stimulus to modify behavior of a subject. In one embodiment, the aversive stimulus may be delivered solely using visual stimuli projected onto one or more viewing screens observable by the subject. The visual stimulus may be a video representation of a real-world environment (e.g., a representation of the physical world captured and replayed by videography), a computer simulation of a real world environment, or abstract images. Desirably, the visual stimulus induces a sense of motion in the subject while the subject remains stationary or substantially stationary. The biological conflict within the subject between the visual system perceiving motion and the vestibular system sensing non-motion induces the aversive stimulus (e.g., dizziness, nausea, etc.) in the subject.

Any visual stimulus that induces a sense of motion and capable of being projected onto the viewing screens may be used in accordance with the principles of this invention. Suitable visual stimuli include, for example, flight simulators, driving simulators, and other existing VR and AR programs and systems that project a viewing environment in motion. In some embodiments, existing motion simulators (e.g., flight simulators) may be projected at speeds above those normally used for simulation purposes in order to enhance the sensation of motion in the subject. In some embodiments, the subject views the motion simulator without having any active interaction with, or control over, the VE being viewed. Alternatively, the subject may be capable of interacting with, and controlling the VE. Interaction and control may include being able to independently oriented the subject's POV within the VE (e.g., by moving the head or eyeballs), altering the motion speed or otherwise controlling navigation through the VE, and/or optionally interacting with virtual objects or virtual representations of physical objects (e.g., through passive haptics).

Optionally, the motion simulation programs may be implemented to introduce latency into the viewing experience, particularly for VEs in which the subject controls its motion or POV within the VE. The introduced latency can be at least 25, 50, 75, 100, 200, 250, 500 ms or more. As discussed above, latency can induce or enhance the adverse effects of VR.

In another embodiment, the aversive visual stimulus may be images that the subject finds disgusting, revolting, or otherwise unpleasant. The immersive experience provided by VR or AR can make the images and situations “feel more real” to the subject, thereby causing nausea or aversion where merely viewing the images using more traditional means (e.g., movie projection or television) would not. These types of aversive visual stimuli often are more effective when paired with other sensory stimuli such as olfaction, as discussed in more detail below. One example of aversive stimuli utilizing augmented or virtual reality that the subject would find fearfully unpleasant would be the use of virtual reality in which an icon or avatar representing the subject would be placed in a cancer hospital environment wherein the represented subject would be subjected to chemotherapy, radiotherapy or surgical procedures associated with lung cancer. This could be complemented by graphic representations of the disfiguring and deteriorating corporal changes of the subject's avatar that are commonly associated with advanced lung cancer and its treatments. Through this technique using highly-realistic VR and AR platforms, the timeframe between the stimulus of cigarette smoking and the aversive cancer-associated consequences thereof would be shortened by decades, thus providing a much more effective aversive conditioning model.

Any of the aversive visual stimuli may be paired with other sensory stimuli. In some embodiments, the adverse effects of visual VR/AR stimuli are paired with olfactory stimuli delivered to the user. This is particularly useful when the desired aversive stimulus is the induction of a nausea and/or revulsion. Suitable olfactory stimuli may be any pungent or putrid odor and may include, for example, the smell of skunk, rotten eggs, hydrogen sulfide, vomit, sewage, feces, etc. In some embodiments, a container (e.g., vial or ampule) is positioned close to the subject's nose while the subject is interacting with the VE. At the appropriate time, usually in coordination with the images being viewed, the odoriferous substance is released in an amount and location that can be readily detected by the subject. Relatedly, the sense of taste may be used to deliver an aversive stimulus instead of, or in addition to, olfaction. In this embodiment, a foul-tasting (nausea-inducing) substance is administered to the subject as above. The release of the aversive stimuli may be automatic (i.e., functionally linked to the visual stimuli) or manually dispensed by a third party (e.g., the VR operator or attending clinician).

In another embodiment, an adverse stimulus may be administered to the subject using the sense of touch. Here again, it is preferable if stimulus administration is coordinated with the visual images experienced by the subject in the VE. Strategies for passive haptics, which allow the user to seamlessly intact with a physical object while viewing and interacting with a digital representation of that object in the VE, are known in the art. Suitable physical objects and stimuli may be used which enhance the aversive effect evoked by the visual stimuli. It is understood that the physical and virtual objects need not be the same and that a substitute physical object may be used to simulate the tactile feel of a different virtual object. For example, oiled and cooked spaghetti may be a physical object that can be used to simulate for the user the feeling of touching snakes or worms in the VE.

In some embodiments, the sensory stimuli, individually or in combination (e.g., visual and olfactory), may be used to induce disgust or revulsion. Suitable stimuli include, for example, stimuli related to any of the disgust domains described above.

Aversive Conditioning

Aversive conditioning relies on functional and physiological pairing within the subject of the aversive stimulus and the behavior to be mitigated or prevented. Typically, aversive conditioning is achieved during a training period consisting of a series/plurality of training sessions in which the aversive training stimulus is administered while the subject is engaged in the behavior. It is preferable that the subject abstains from the behavior during the training period other than during the training sessions. The goal of the training period is to condition the subject to experience the aversive condition when engaged in the targeted behavior even in the absence of the training stimulus. If successful, the subject will abstain from the behavior even after the training period has ended. It is understood that additional training periods may be intermittently required to reinforce the aversive conditioning. The following discussion of aversive conditioning refers to smoking reduction or cessation for convenience or clarity but is equally applicable to mitigating any undesired behavior.

Training Session Administration:

The use of a VR or AR device to administer the aversive conditioning provides a great deal of flexibility in the timing and location of the administration. Training sessions may be administered in a clinical or office setting under the supervision of a medical profession or other counselor, self-administered, or a combination of the two. For example, initial training sessions may be performed in the presence of a clinician to ensure suitable monitoring of the subject and control and calibrate of the level of aversive stimuli and/or the magnitude of the aversive condition, administering medical treatment if necessary. The user then may take home the portable VR or AR device to administer additional training sessions on a scheduled or as-needed basis in order to complete the conditioning protocol. Additionally, a clinical or supervised setting may be used to administer aversive stimuli other than visual stimuli (e.g., when paired with olfactory, gustatory, and/or tactile stimuli), whereas unsupervised training may be limited to aversive visual stimuli only. Training and assisted sessions may also take place over a video call. In the context of smoking cessation, one or more of the initial training sessions may be administered by a clinician in order to familiarize the subject with the system and its effects (either in person or over a video call). The subject then may administer a training session at home each time she feels the urge to smoke a cigarette and/or while actually smoking a cigarette.

Aversive Training

The training period may comprise any effective duration and may include any effective number of training sessions. For example, training sessions may occur once, twice or three times each day, or more, or once a week or less. Each training session has a sufficient duration for the subject to engage in the targeted behavior while exposed to aversive stimuli for a duration sufficient to induce the aversive effect within the subject. The specifics of the training sessions are modified depending upon the type and severity of the targeted behavior.

The training period may be used as an opportunity to begin reducing the targeted behavior by reducing the behavior threshold at which the aversive stimuli is administered. For example, in the case of smoking cessation, the subject may be allowed to smoke a full cigarette during the first training session, three quarters of a cigarette during the second training session, half a cigarette during the third training session, and so forth.

In some embodiments, the magnitude of the aversive stimulus may be varied between training or administration sessions. For example, a first training session or series of training sessions may deliver a relatively mild aversive stimulus in order to ascertain the subject's tolerance to the aversive stimulus and/or to determine whether a relatively mild stimulus is sufficient to cause behavioral modification and/or achieve conditioning. The magnitude of the aversive stimulus may be increased either continuously or incrementally during the training session, between training sessions, or both. Aversive stimuli of greater magnitude may be required to mitigate and/or condition stronger or more ingrained behaviors (e.g., addictions) and/or to account for inter-individual variability. Some individuals may become desensitized to the aversive stimulus over the course of repeated administrations such that an aversive stimulus sufficient to produce a certain aversive condition during a first or early session may not induce the same level of aversive condition upon repeated exposure. Alternatively, the magnitude of the aversive stimulus may be increased in order to induce a stronger aversive condition in the subject upon repeated/subsequent administrations. For example, early administrations may be modulated to induce a mild feeling of nausea, whereas the magnitude of the aversive stimulus may be increased in subsequent administrations in order to induce severe nausea or even involuntary vomiting in later sessions.

It is understood that not all modalities of the aversive stimulus must be used together or increases/decreased simultaneously. For example, a first administration may involve only the visual representation of a motion simulator running at a first speed. The magnitude may be increased by running the motion simulator at a second, faster speed. The magnitude may be further increased by altering the visual images of the motion simulator and/or introducing an aversive olfactory stimulus. The magnitude may be again increased by introducing a third aversive stimulus. For example, in the case of smoking cessation, the cigarette may be adulterated with a compound that, when burnt or inhaled, imparts an offensive smell and/or taste. Other methods for increasing the magnitude of the aversive stimulus may include increasing the latency of the visual images viewed by the subject, as described herein.

Targeted Behaviors

Undesired behaviors that can be aversively conditioned with the VR and AR systems and methods described herein include, without limitation, avoidance or reduction of smoking and other nicotine products (e.g., chewing tobacco, e-cigarettes (“vaping”), etc.), alcohol, prescription pharmaceuticals, illicit substances (e.g., cocaine, heroin, marijuana, hallucinogens, etc.), eating certain foods, overall caloric intake, fat intake, sodium intake, allergens, inhalants, and other agents known to cause or exacerbate illness or disease, and other social behaviors such as high-risk sexual behaviors and gambling. For example, for weight loss, undesired behaviors may include eating excessive calories (e.g., binge eating), fats, or certain carbohydrates.

Exemplary Protocol: Smoking Cessation

The following is an exemplary aversive training protocol that may be used to condition a light to moderate smoker. The subject is required to abstain from smoking outside of the training sessions during the training period. Phase 1 consists of two training sessions each day as outlined in the following table. All indicated actions are performed while wearing the VR device and viewing a motion simulation in a VE. The training session is continued, and the aversive stimulus is maintained or increased in magnitude until the target effect is achieved.

| Training | | |
|---|---|---|
| Day | Action | Target Effect |
| 1 | Smoke two cigarettes | motion sickness and/or nausea |
| 2 | Smoke one and a half | motion sickness and/or nausea |
| | cigarettes | |
| 3 | Smoke one cigarette | motion sickness and/or nausea |
| 4 | Smoke ⅔ of a cigarette | motion sickness and/or nausea |
| 5 | Smoke ½ of a cigarette | motion sickness and/or nausea |
| 6 | Smoke ¼ of a cigarette | motion sickness and/or nausea |
| 7 | Light but do not smoke a | motion sickness and/or nausea |
| | cigarette | |
| 8 | Hold but do not light a | motion sickness and/or nausea |
| | cigarette | |

Optionally, Phase 2 of training is administered in which the subject has access to the VR or AR device and self-administers a training session either when having an urge to smoke a cigarette and/or when actually smoking a cigarette. Phase 2 may last for one or more days, one, two, three, four weeks, or more.

Following the completion of Phase 1 (or optionally Phase 2), the subject is monitored or self-reports smoking habits. If completely successful, the subject abstains from smoking indefinitely. If the subject smokes at all or beyond a pre-determined threshold (e.g., based on frequency and/or number of cigarettes), a second or subsequent training period is initiated. Optionally, the second training period (i) mandates a reduction in the undesired behavior relative to the level used in the earlier training periods (e.g., reduced number of cigarettes permitted to be smoked during each training session relative to the comparable training session during the earlier period), (ii) has an increased or reduced duration relative to the earlier training period, (iii) increases the magnitude or severity of the target effect required before cessation of the aversive stimulus, and/or (iv) increases or reduces the number of training sessions or the frequency of training sessions within the training period. It is understood that the specific protocol for any training period, whether a first or subsequent training, is varied based on the specific behavior targeted and the severity of that behavior.

Aversive Stimulation without Conditioning/Training

The systems and methods of the invention also may be used to deliver an aversive stimulus, sufficient to induce an aversive condition, but that does not result in classic conditioning as described above. Thus, the aversive stimulus may be used to acutely modify or extinguish the unwanted behavior. As above, these protocols may be administered under the supervision of a clinician, self-administered, or a combination of both. The basis of these protocols is to temporaneously or contemporaneously administer the aversive stimulus either during the craving phase of the unwanted behavior, during performance of the behavior itself, or both.

In some embodiments, the aversive stimulus is delivered during the craving stage that occurs before the subject actually engages in the unwanted behavior. Under conditions that do not induce classic conditioning, the goal of the protocol is to mitigate or extinguish/eliminate the craving by inducing an aversive condition (e.g., nausea and/or vomiting) in the subject, thereby reducing or preventing the subject's voluntary engagement in the behavior. For example, in the case of smoking or binge eating, the subject self-identifies as having a craving to engage in the unwanted behavior (e.g., smoking or over-eating) and then is administered (either by self-administration or under the supervision of a clinician) an aversive stimulus sufficient to induce an aversive condition (e.g., a feeling of nausea). The aversive condition then mitigates or replaces the craving felt by the subject, thereby mitigating the subject's urge to engage in the unwanted behavior. This type of behavioral modification is particularly useful for self-administration because it does not require the subject to resist its cravings and urges during the time between clinical administrations of the aversive stimulus. All that is required is for the user to self-administer the aversive stimulus immediately upon the onset of a craving, thereby preventing or reducing the unwanted behavior. Alternatively, this acute delivery may be self-administered while the user is engaged in the unwanted behavior in order to reduce the duration (i.e., mitigate) that behavior. Repeated use may or may not result in classic aversive conditioning.

Emesis Induction

In some instances, it is desirable to induce emesis (vomiting) for medical purposes that are not linked to behavioral modification. For example, vomiting may be induced to partially or completely empty the stomach of its contents after the non-intentional or intentional ingestion of poisonous substances including over-doses of pharmacological or illicit substances. Syrup of Ipecac (ipecac) is an over-the-counter emetic that is plant-derived and works both, locally, by irritating the gastric mucosa and, centrally, by stimulating chemoreceptors in the medullary region of the brain. Significant questions have emerged as to ipecac's safety and effectiveness. Current guidelines from the American Academy of Pediatrics and other medical specialty organizations strongly advise against ipecac's use on outpatient bases, and its use in emergency centers is also greatly reduced because of its sedative activity (which can be confused with the actions of the ingested substance) and because of the dangers associated with its being aspirated.

Vomiting also can be induced by stimulating the gag reflex in the posterior pharynx to cause regurgitation of non-digested foods in the stomach. This is a common and dangerous practice among people with the condition of bulimia nervosa that involves cycles of binge eating and self-induced regurgitation by digital stimulation of the gag reflex. Digitally-stimulated regurgitation does not involve nausea, which is the aversive sensation involved in central-nervous system-initiated emesis. Bulimics (i.e., subjects having bulimia nervosa) who regularly self-induce regurgitation report that they do not find the practice uncomfortable.

It will be appreciated by persons having ordinary skill in the art that many variations, additions, modifications, and other applications may be made to what has been particularly shown and described herein by way of embodiments, without departing from the spirit or scope of the invention. Therefore, it is intended that scope of the invention, as defined by the claims below, includes all foreseeable variations, additions, modifications or applications.

1. A method for aversively conditioning a behavior in a subject, comprising:
(i) performing a training session by:
(a) providing a virtual or augmented reality system and software for creating a virtual environment viewable by the subject using the virtual reality or augmented reality system, wherein the virtual environment is capable of inducing an adverse physiological effect in the subject when viewed;
(b) having the subject view the virtual environment while engaging in the behavior until the adverse physiological effect is effected; and
(c) terminating the behavior and the virtual environment viewing;
(ii) providing an interval period for permitting the subject to abstain from the behavior; and
(iii) repeating the training session of step (i) one or more times, wherein the interval period of step (ii) is provided between each repetition.

2. The method of claim 1, wherein the virtual environment is a motion simulator.

3. The method of claim 1, wherein the behavior is smoking or binge eating.

4. The method of claim 1, wherein the behavior is self-administration of a prescribed pharmaceutical or illegal substance.

5. The method of claim 1, wherein the adverse physiological effect is dizziness, nausea, vomiting, or revulsion.

6. The method of claim 1, wherein step (i) is repeated seven or more times.

7. The method of claim 1, wherein the virtual or augmented reality system further comprises a second sensory modality.

8. The method of claim 7, wherein the second sensory modality is olfaction.

9. The method of claim 1, wherein the interval period is one day or less.

10. A method for mitigating an unwanted behavior in a subject, comprising:
(i) identifying an unwanted behavior in a subject;
(ii) identifying a time period during which the subject has a desire to engage in the behavior;
(iii) inducing an adverse physiological effect in the subject by:
(a) providing a virtual or augmented reality system and software for creating a virtual environment viewable by the subject using the virtual reality or augmented reality system, wherein the virtual environment is capable of inducing the adverse physiological effect in the subject when viewed; and
(b) having the subject view the virtual environment during the time period until the adverse physiological effect is effected; and
(iv) terminating the virtual environment viewing when the subject no longer has a desire to engage in the behavior.

11. The method of claim 10, wherein the virtual environment is a motion simulator.

12. The method of claim 10, wherein the behavior is smoking or binge eating.

13. The method of claim 10, wherein the behavior is self-administration of a prescribed pharmaceutical or illegal substance.

14. The method of claim 10, wherein the adverse physiological effect is dizziness, nausea, vomiting, or revulsion.

15. The method of claim 10, wherein the virtual or augmented reality system further comprises a second sensory modality.

16. The method of claim 15, wherein the second sensory modality is olfaction.

17. A method for inducing vomiting in a subject, comprising:
(i) providing a virtual or augmented reality system and software for creating a virtual environment that may be experienced by the subject using the virtual reality or augmented reality system, wherein the virtual environment is capable of inducing vomiting when experienced by the subject;
(ii) having the subject experience the virtual environment during the time period until vomiting is effected; and
(iii) terminating the virtual environment experience after the subject has vomited.

18. The method of claim 17, wherein the virtual environment is a motion simulator.

19. The method of claim 17, wherein the virtual or augmented reality system further comprises a second sensory modality.

20. The method of claim 19, wherein the second sensory modality is olfaction.

21. The method of claim 17, further comprising identifying the subject as having ingested a toxic substance prior to performing step (ii).

22. The method of claim 21, wherein step (ii) is performed within one hour of toxic substance ingestion by the subject.

23. A virtual reality or augmented reality system, comprising:
a plurality of display devices configured to be viewed by a subject;
a software program capable of displaying a first image on the display devices in response to a first point of view of the subject and a second image on the display devices in response to a subject's second point of view, wherein the second image is related to the first image by the difference between the second point of view and the first point of view; and
a sensor capable of detecting a subject's first point of view at a first time and a second point of view of the subject at a second time,
wherein the software program is configured to provide a latency of 50 milliseconds or more between a detection in the second point of view by the sensor and the display of the second image.

24. The system of claim 23, wherein the sensor detects a change in a position of a head of the subject.

25. The system of claim 23, wherein the sensor detects a change in a position of an eye of the subject.
